(19) United States
(12) Patent Application Publication
(10) Pub. No.: US 2019/0325420 A1
(43) Pub. Date: Oct. 24, 2019

(54) Wireless Network Services Operating with Blockchain Technology

(71) Applicant: CROSSOVER CAPITAL, San Francisco, CA (US)

(72) Inventor: Dean Gardner, San Francisco, CA (US)

(73) Assignee: CROSSOVER CAPITAL, San Francisco, CA (US)

(21) Appl. No.: 16/389,923

(22) Filed: Apr. 20, 2019

Related U.S. Application Data
(60) Provisional application No. 62/660,955, filed on Apr. 21, 2018.

(51) Int. Cl. G06Q 20/32; H04L 12/14; H04W 4/24; H04W 16/14; H04B 7/0452; G06Q 20/38; G06Q 20/06

(52) U.S. Cl. CPC G06Q 20/325; H04L 12/146; H04W 4/24; H04W 84/18; H04B 7/0452; G06Q 20/389; G06Q 20/0658; H04W 16/14

(57) ABSTRACT

Embodiments of the invention relate to systems and methods pertaining to wireless network technology. More particularly, an embodiment of the invention relates to systems and methods that employ wireless communication units and wireless base stations to provide Internet access and other communication services in exchange for an expenditure of a cryptocurrency. A related blockchain network may include mining computers that have been adapted to include specialized hardware dedicated to performing financial calculations related to cryptocurrency.

### FIELD

Embodiments of the invention relate to systems and methods pertaining to wireless network technology. More particularly, an embodiment of the invention relates to systems and methods that employ wireless communication units and wireless base stations to provide Internet access and other communication services in exchange for an expenditure of a cryptocurrency.

### BACKGROUND

The following description includes information that may be useful in understanding embodiments of the invention. It is not an admission that any of the information provided herein is prior art or relevant to the presently claimed invention, or that any publication specifically or implicitly referenced is prior art.

Some seventy percent of the world has no access to the high speed Internet networks provided by wired fiber cable.

In addition, consumers demand higher and higher, gigabit access via wireless communications at performance and costs that incumbent industry providers have thus far not been able to supply via advanced wireless technologies such as those operating on 5G networks.

Therefore, a need exists for improved wireless communications technologies to provide high speed Internet access as well as other communication services at improved rates of performance and lower costs than devices found in the prior art.

In addition, many new approaches for handling merchant transactions at the network level are simply too slow and cumbersome. Among other things, latency levels are typically too high, thwarting the complete potential for many of these new approaches which otherwise have much to offer. Overcoming these obstacles in a cost-effective manner has proved to be extremely difficult.

### SUMMARY OF THE INVENTION

Embodiments of the invention provide a distributed wireless network, that comprises a plurality of wireless communication units, a plurality of wireless base stations, and a blockchain network that comprises a plurality of interlinked network mining computers. Each communication unit of the plurality of wireless communication units has a processor, a memory having a cryptocurrency bank, and an adaptive antenna array capable of using a non-line-of-sight propagation channel. Each wireless base station of the plurality of wireless base stations has a processor, an adaptive antenna array capable of using a non-line-of-sight propagation channel, wherein the adaptive antenna array and an adaptive antenna array of a wireless communication unit of the plurality of wireless communication units form at least one communication link, and an Internet communication switch. Each network mining computer in the plurality of interlinked network mining computers has an account ledger in its memory having an entry corresponding to the cryptocurrency bank. The processor in a communication unit of the plurality of communication units sends an Internet access request to a wireless base station of the plurality of wireless base stations via the adaptive antenna array, wherein the processor in the wireless base station of the plurality of wireless base stations sends the Internet access request to the blockchain network wherein each network mining computer receives the Internet access request, decrements the entry corresponding to the cryptocurrency bank, grants Internet access, wherein the blockchain network sends an Internet grant message to the wireless base station of the plurality of wireless base stations, wherein the wireless base station of the plurality of wireless base stations sends the Internet grant message to the communication unit of the plurality of communication units, and wherein the processor in the communication unit of the plurality of communication units decrements the cryptocurrency bank by an amount corresponding to the Internet grant message.

Embodiments of the invention further provide an open, distributed gigabit wireless network. The network may connect consumers, as well as enterprises and governments, to an open wireless network of networks using a cost effective decentralized global wireless network. The network's performance and monetization may be achieved using blockchaining in combination with a cryptocurrency.

Embodiments of the invention enable a secure, open decentralized gigabit wireless network that sits on top of a blockchain network. The gigabit wireless network may be built and grown in conjunction with network builders based on an appropriate set of policies, procedures, and rules.

Embodiments of the invention provide a wireless network controlled by a cryptocurrency that acts as the network's native asset. The cryptocurrency may have a specialized form (e.g., a “gigacoin” designed for use in a specific network) and/or a more generalized type of cryptocurrency (e.g., a Bitcoin designed for all cryptocurrency purposes). The cryptocurrency may be built into the wireless network and stored on the collective account ledgers in the blockchain network. Each network mining computer may have a memory that includes an account ledger holding cryptocurrency. The cryptocurrency may be used, among other things, to buy and sell wireless access for use in the wireless network. The cryptocurrency contributes to the ability to provide wireless access worldwide and to conduct transactions between the buyers and sellers quickly and securely.

### BRIEF DESCRIPTION OF THE DRAWINGS

Figures provided herein may or may not be provided to scale. The relative dimensions or proportions may vary.

FIG. 1 illustrates a wireless network 103 that employs a plurality of wireless communication units 101, each wireless communication unit 101 having an adaptive antenna array 109, a plurality of wireless base stations 118, each wireless base station 118 having an adaptive antenna array 112 and an Internet communication switch 114 configured for communication with an Internet 119 that includes a blockchain network 121 comprised of network mining computers 201-208, according to, an embodiment of the invention.

FIG. 2A illustrates an Internet 219 (similar to the Internet 119 shown in FIG. 1) that comprises a specialized blockchain network 221 that itself includes network mining computers 211-218 that have been adapted to include a dedicated merchant layer provided by specialized hardware, according, to an embodiment of the invention.

FIG. 2B illustrates a representative network mining computer 211 that includes a specialized processor 211a configured to process merchant transactions quickly in the account ledger in the memory 219 of the network mining computer 211 to enable the network mining computer 211 to pass on relevant transaction data to other network mining computers 212-218 of the blockchain 221 which also include specialized processors like the specialized processor 211a, according to an embodiment of the invention.

### DETAILED DESCRIPTION OF AN EMBODIMENT OF THE INVENTION

Embodiments of the invention provide an open, distributed gigabit wireless network. The wireless network may connect consumers, as well as enterprises and governments, to an open wireless network of networks using a cost effective decentralized global wireless network. The network's performance and monetization may be achieved using blockchaining in combination with a cryptocurrency.

Embodiments of the invention enable a secure, open decentralized gigabit wireless network that sits on top of a blockchain network. The wireless network may be built and grown in conjunction with “network builders” based on an appropriate set of policies, procedures, and rules.

Embodiments of the network may be powered by a cryptocurrency which acts as the network's native asset. The cryptocurrency may have a specialized form (e.g., a “gigacoin” designed for use in a specific network) and/or a more generalized type of cryptocurrency (e.g., a bitcoin designed for all cryptocurrency purposes). The cryptocurrency may operate throughout the wireless network and be stored in the distributed ledger stored among the network mining computers on a blockchain network. The cryptocurrency may be used, among other things, to buy and sell access to the wireless network. The cryptocurrency contributes to the ability to provide wireless access worldwide and to conduct transactions between the buyers and sellers quickly and securely, according to an embodiment of the invention.

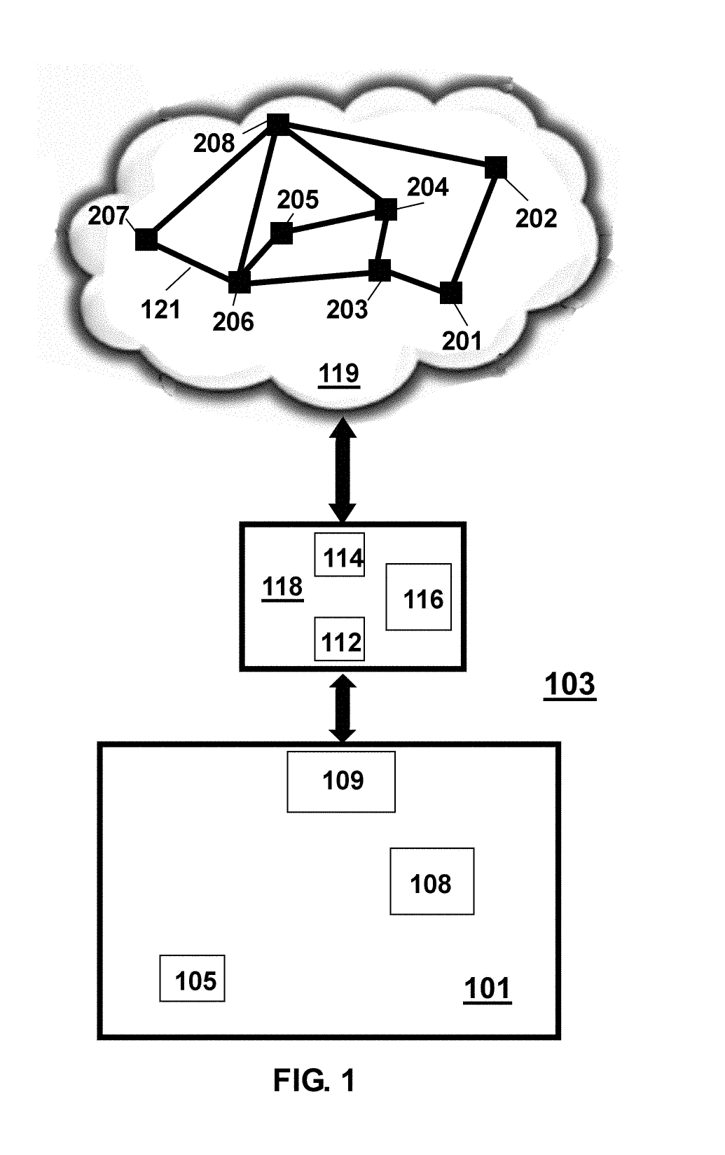

FIG. 1 illustrates a wireless network 103 that employs a plurality of wireless communication units 101, each wireless communication unit 101 having an adaptive antenna array 109, a plurality of wireless base stations 118, each wireless base station 118 having an adaptive antenna array 112 and an Internet communication switch 114 configured for communication with an Internet 119 that includes a blockchain network 121 comprised of network mining computers 201-208, according to an embodiment of the invention. For ease of understanding, FIG. 1 illustrates a single wireless communication unit 101 of the plurality of such wireless communications units 101 and a single wireless base station 118 of the plurality of such wireless base stations 118.

The wireless network 103 may comprise multiple wireless communication units 101 communicating to one wireless base station 118 of the plurality of wireless base stations 118. The wireless network 103 may also comprise an essentially unlimited number of wireless base stations 118 communicating to the Internet 119, according to an embodiment of the invention.

The wireless network 103 provides a common wireless platform that is designed to be open and accessible to any user having access to a wireless communication unit 101 holding enough cryptocurrency in a cryptocurrency bank 108 to pay for access to the Internet 119, according to an embodiment of the invention.

The wireless communication unit 101 includes a processor 105, a cryptocurrency bank 108, and an adaptive antenna array transceiver 109, according to an embodiment of the invention, The wireless communication unit 101 may include other structural components. The cryptocurrency bank 108 comprises a secured portion of computer memory configured to hold cryptocurrency. The cryptocurrency bank 108 should be configured to secured against tampering by the world at large, including the user of the wireless communication unit 101. The cryptocurrency bank 108 may include an indicia of an amount of cryptocurrency with the actual cryptocurrency held in the collective account ledgers of the block chain network 121, e.g., in the account ledgers stored in the memories of the network mining computers.

The processor 105 may comprise a CPU or other computer processor capable of executing instructions and programs. The wireless communication unit 101 may comprise a variety of computing devices that include processors and memories capable of holding the cryptocurrency bank 108, such as a desktop computer, a laptop computer, a pad computer, and/or a mobile phone where the adaptive antenna array transceiver 112 is added as a plug-in (e.g., via a USB port) to the computing device to form the wireless communication unit 101, according to an embodiment of the invention.

The wireless base station 118 comprises an adaptive antenna array transceiver 112, a processor 116, and an Internet communication switch 114, according to an embodiment of the invention. The wireless base station 118 may include other structural components as well. Similarly to the wireless communication unit 101, the wireless base station 118 may be assembled by taking an otherwise appropriate computing device (e.g. a mid-range computing device) and attaching (e.g., via a USB port) an adaptive antenna array to form the wireless base station 118, according to an embodiment of the invention.

The wireless base station 118 of the plurality of wireless base stations 118 and a wireless communication unit 101 of the plurality of wireless communication units 101 provide the infrastructure for enabling users of the wireless communication units 101 to access wireless services provided by the wireless network 103 and the Internet 119, according to an, embodiment of the invention.

The wireless base station 118 and the communication unit 101 may employ wireless technology in the adaptive antenna array transceiver 112 and the adaptive antenna array transceiver 109 that are resilient to obstructions, interference, and motion that intemperate together and can be configured to operate in a variety of spectrums.

One such combination of wireless base station 118 adaptive antenna array transceivers 112 and communication unit 101 adaptive antenna array transceivers 109 can be supplied by Tarana Wireless.

The Tarana system is particularly adapted to provide a wireless system for backhaul applications, wireless Ethernet replacement applications and broadband wireless drop applications. In the Tarana system, a central broadcast radio in a wireless base station (e.g., the wireless base station 118) has an adaptive antenna array. Multiple terminal broadcast radios in terminals (e.g., wireless communication units 101) communicate wirelessly with the central broadcast radio, each terminal broadcast radio having an adaptive antenna array. In the Tarana system, the central broadcast radio and the one or more terminal broadcast radios communicate using one or more links formed by the adaptive antenna arrays that are capable of using a non-line of sight propagation channel. In addition, in the Tarana systems, a beamforming network coupled to the adaptive antenna arrays performs time-space adaptive processing of each link to optimally equalize a multipath channel to enhance signal to noise ratio. The beamforming network uses extreme interference cancellation that inverts a channel from each adaptive antenna in the adaptive antenna array and eliminates interference between the channels from each adaptive antenna in the adaptive antenna array, by directing spatial nulls in the array antenna pattern in the directions of all interfering terminal broadcast radio forming a beam peak in the direction of the desired terminal broadcast radio.

These Tarana devices are described in a variety of patent documents such as U.S. Pat. No. 9,325,409, “Non-Line of Sight Wireless Communication System and Method;” U.S. 2016/0135060, “Non-Line of Sight Wireless Communication System and Method;” U.S. 2016/0164586, “Non-Line of Sight Wireless Communication System and Method;” U.S. 2014/0269785, “Precision Array Processing Using Semi-Coherent Transceivers;” U.S. Pat. No. 9,252,908, “Non-line of sight wireless communication system and method,” and U.S. Pat. No. 9,735,940, “System architecture for optimizing the capacity of adaptive array systems”. All these patents and applications are incorporated by reference herein.

Leveraging the emerging 3GPP 5G communication standard, Tarana Wireless's transceivers provide a commercially validated distributed massive multiple-input and multiple-output (“MIMO”) (e.g., DMM) architecture that enables high throughput and bandwidth in real-time multi-radio processing.

The wireless base station 118 adaptive antenna array transceiver 112 operates in a non-line-of-sight (NLoS) manner, achieved by collection and near perfect re-assembly of multipath signals even in extreme conditions, according to an embodiment of the invention. The wireless base stations 118 of this design (e.g., base stations provided by Tarana Wireless) require 100 times fewer base stations per square kilometer than mm-wave solutions, according to an embodiment of the invention.

The adaptive antenna array transceivers 112 of the base stations 118 also provide uniform gigabit service to the edge of cellular connectivity as well as throughout the cell, through autonomous active self-interference cancellation (involving both clients and base stations, within and between cells), according to an embodiment of the invention. The wireless communication units 101 are similarly configured to interoperate with the wireless base stations 118, according to an embodiment of the invention.

The adaptive antenna array transceivers 112 in base stations 118 may provide as much as 105 BPS/Hz spectral efficiency for outdoor wireless in sub-6 GHz bands, especially when the base stations 118 have been provided using base stations from Tarana Wireless, according to an embodiment of the invention.

The adaptive antenna array transceivers 112 in base stations 118 may be configured to provide 10 Gbps capacity, with multiple simultaneous gigabit users per sector, enabled by very precise digital beam and null-forming, with support for simultaneous fixed, mobile, and Internet of Things (IoT) access, according to an embodiment of the invention.

The adaptive antenna array transceivers 112 in the wireless base stations 118 also offer unlicensed interference cancellation that extracts nearly perfect high-rate signals despite heavy interference from many unlicensed interferers that would simply overpower conventional radios, according to an embodiment of the invention.

The adaptive antenna array transceiver 109 in the wireless communication unit 101 and the adaptive antenna array transceiver 112 of the wireless base station 118 may be configured for operation in an unregulated part of the radio spectrum, according to an embodiment of the invention. Thus, in some configurations the wireless network 103 operates in, a free and unregulated part of the radio spectrum.

The wireless network 103 supports fixed, mobile, and IoT services delivered by the common platform of the plurality of wireless communication units and the plurality of wireless base stations, according to an embodiment of the invention. One advantage of the wireless network 103 is unique spectrum capacity: carrier-grade unlicensed operation and increased (e.g., 10× more) capacity in licensed bands, according to an embodiment of the invention.

Adding additional wireless base stations 118 and wireless communication units 101 in some jurisdictions may encounter additional legal obstacles that may be necessary from a legal but not a technical perspective. An ordinary artisan should understand how to design and build a network that conforms to the appropriate legal and regulatory regime.

The wireless base stations 112 may provide equivalent coverage to a larger collection of conventional base stations, e.g., one hundred times fewer base stations per km² than mm-wave, ten times fewer than 4G/5G in lower frequency bands, especially when the Tarana Wireless equipment described above is used. These base stations may also be significantly cheaper and 5-10 faster to deploy when compared to either fiber or mm-wave, according to an embodiment of the invention.

In an alternative embodiment of the invention, the wireless network 103 may be configured to operate at low speeds and/or free of charge. In other words, the cryptocurrency bank 108 may be empty or not even present in such embodiments. In some embodiments, the wireless network 103 may operate at lower speeds if the cryptocurrency bank 108 is empty and/or the service may be monetized in another way, e.g., via advertisement. In other words, in some embodiments, a user having access to a wireless communication unit 101 may have Internet access even when the cryptocurrency bank 108 on this wireless communication 101 is empty. Such embodiments simplify the process for allowing users to purchase (or replenish) cryptocurrency for services in the wireless network 103, such as high speed access.

The blockchain network 121 in the Internet 119 provides a secure and transparent network that, removes uncertainties from the overall network, including elements such as the network's quality of service and network speed, while simplifying complicated tasks via a peer-to-peer wireless system. The blockchain network 121 also simplifies other characteristics of the wireless network 103, such as its value and, the cost of building out the wireless network 103, as well as simplifying the purchase of additional cryptocurrency, according to an embodiment of the invention.

The wireless network 103 may provide an open and affordable wireless communication system where people and entities of all income levels can access simple-to-use, secure, and low cost wireless services. The wireless network 103 may also empower developers to create additional wireless products and services for their communities, e.g., security, payments, data analytics, vertical apps, etc.

The wireless network 103 provides direct, parallel support of 5G mobile clients, with all the benefits described herein and delivered in connected-vehicle applications that support enhanced forms of Dynamic Map Manager (DMM) architectures, according to an embodiment of the invention.

Cryptocurrency, such as the cryptocurrency in the cryptocurrency bank 108 (or indicated by the cryptocurrency bank 108 but actually stored in the collective account ledgers of the blockchain network 121, e.g. in the memories of the network mining computers), may serve as the native asset of the wireless network 103, according to an embodiment of the invention. “Native” here means that cryptocurrency is built into the wireless network 103. “Asset” represents how the wireless network 103 refers to an item of value that is stored on the collective account ledger in the blockchain network 121, e.g., in the memories of the network mining computers.

The cryptocurrency in the wireless network 103 offers all the innovative features of a shared public ledger on a distributed database and network—often referred to as blockchain technology—the shared public ledger comprising linked individual account ledgers in the memories of the network mining computers. The wireless network's 103 built-in cryptocurrency in the cryptocurrency bank 108 may serve two additional purposes:
First, the cryptocurrency may play a small anti-spam role.
Second, the cryptocurrency may facilitate multi-currency transactions.

In terms of the first point, each transaction in the wireless network 103 may include a minor fee (e.g., 0.00001 cryptocurrency units). This fee prevents users with malicious intentions from flooding the network (otherwise known as a “denial of service” (“DoS”) attack). The cryptocurrency works as a security token, mitigating DOS attacks that attempt to generate large numbers of transactions or consume large amounts of space in the ledger.

Similarly, the wireless network 103 requires all accounts to hold a minimum balance of some number of cryptocurrency (e.g., 20 cryptocurrency units), according to an embodiment of the invention. This requirement helps ensure that accounts in the wireless network 103 are authentic, which helps the wireless network 103 maintain a seamless flow of network and transactions, according to an embodiment of the invention.

In terms of the second point above, the cryptocurrency may facilitate trades between pairs of currencies for which there is not a large direct market, acting as a bridge, according to an embodiment of the invention. This function is possible when there is a liquid market between the cryptocurrency (e.g., gigacoin, etc.) and each currency involved.

The cryptocurrency may be used to purchase equipment, such as the wireless communication unit 101 from an equipment supplier, e.g., Tarana Wireless. The cryptocurrency may also be used to purchase wireless access, according to an embodiment of the invention.

The cryptocurrency sits on top of Blockchain network 121, according to an embodiment of the invention. At initiation of the wireless network 103 some amount of cryptocurrency may be made available to users via the cryptocurrency bank 108 in their respective wireless communication units 101, according to an embodiment of the invention. Alternatively, an indicia of the cryptocurrency may be held in the cryptocurrency bank 108 with the actual cryptocurrency held in the blockchain network 121, which acts as a ledger for the cryptocurrency, e.g., account ledgers stored in the memories of the network mining computers 201-208.

Network builders are an aspect of the cryptocurrency as a contextual cryptocurrency system.

The blockchain protocol/techniques used in connection with the blockchain network 121 may apply conventional techniques, such as “Bitcoin: A Peer-to-Peer Electronic Cash System,” by Satoshi Nakamoto in 2009, https://bitcoin.org/bitcoin.pdf, accessed Apr. 17, 2018; “Blockchains: The great chain of being sure about things”. The Economist. 31 Oct. 2015. Archived from the original on 3 Jul. 2016. Retrieved 18 Jun. 2016, last accessed Apr. 17, 2018; U.S. 2016/0177061, entitled “Secure Data Parser Method and System;” U.S. 2014/0081784, entitled “Payment Method, Payment Server Performing the Same and Payment System Performing the Same,” and U.S. 2016/0342978, entitled “Method and System for Integration of Market Exchange and Issuer Processing for Blockchained-Based Transactions.” All of these publications, patents and applications are incorporated by reference herein.

A representative cryptocurrency transaction could take place as follows, according to an embodiment of the invention. The processor 105 in a communication unit 101 of the plurality of communication units sends an Internet access request to the wireless base station 118 via the adaptive antenna array 109, wherein the processor 116 in the wireless base station 118 sends the Internet access request to the blockchain network 121 wherein each network mining computer 201-208 receives the Internet access request, decrements an entry in its account ledger corresponding to the cryptocurrency bank 108 in the communication unit 101 by an amount corresponding to a price for Internet access. When the network work mining computers 201-208 have completed their tasks, the blockchain network 121 grants Internet access and sends an Internet access grant message to the wireless base station 118. The wireless base station 118 sends the Internet grant message for the communication unit 101 and records in its memory that the communication unit 101 has Internet access and enables the Internet access switch 114 for the communication unit 101. The processor 105 in the communication unit of the plurality of communication units decrements the cryptocurrency bank 108 by an amount corresponding to the Internet grant message, according to an embodiment of the invention.

At initiation of the wireless network 103, the network operator may allow builders and distributors to sign up for cryptocurrency. The goal of the direct sign-up program is to make cryptocurrency readily accessible to a wide range of potential customers by implementing a simple mechanism for distribution featuring a low barrier to entry, Alternatively, the cryptocurrency may be loaded into various wireless communication units 101, according to an embodiment of the invention.

With more users holding cryptocurrency and transacting on the wireless network 103, the wireless network 103 itself may become more useful to those actors who build low-cost services on it.

The cryptocurrency used in the wireless network 103 may include a built-in, fixed, nominal inflation mechanism, according to an embodiment of the invention. New cryptocurrency may be added to the wireless network 103 at the rate of given rate (e.g., 1% each year). For some time interval (e.g., each week), the wireless network 103 may be programmed to distribute cryptocurrency to any user account that receives some number of votes (e.g., 0.05% of the “votes”) from other users' accounts in the wireless network 103, according to an embodiment of the invention.

The blockchain network 121 provides a timestamping function in the wireless network 103, according to an embodiment of the invention. Trusted time stamping, provided by the blockchain network 121, provides a process for securely tracking the creation and modification time of an object or another document. This timestamping can provide a useful tool in the business world. Timestamping allows interested parties to know, without a doubt, that a document in question existed at a particular date and time. By design, a cryptocurrency transaction includes a date and time, held on the blockchain network 121. By including a cryptographic digest of a file users can later certify that the, data existed at that time, according to an embodiment of the invention. For many businesses, the cost and time savings associated with access to facilities for entering into agreements and signing contracts securely online is something'that may save significant funds (e.g., billions of dollars annually).

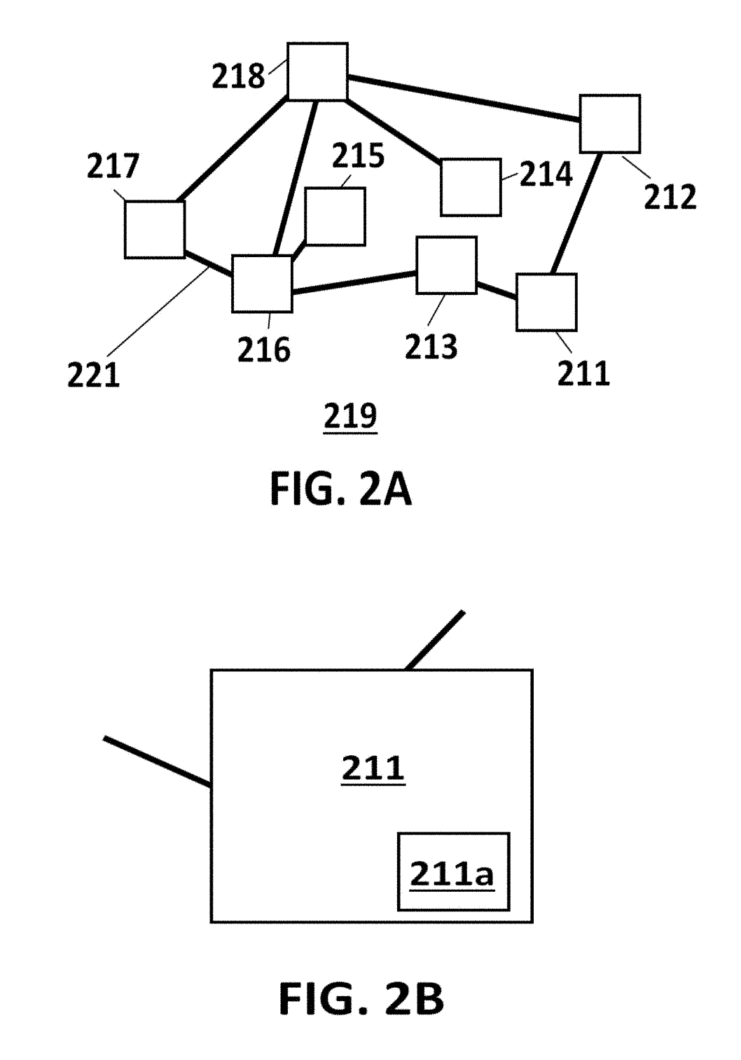

FIG. 2A illustrates an Internet 219 (similar to the Internet 119 shown in FIG. 1) comprising a specialized blockchain network 221 that itself includes network mining computers 211-218 that have been adapted to include a dedicated merchant layer provided by specialized hardware, according to an embodiment of the invention. FIG. 2B illustrates a representative network mining computer 211 that includes a specialized processor 211a configured to process merchant transactions quickly in the account ledger in the memory 219 of the network mining computer 211 to enable the network mining computer 211 to pass on relevant transaction data to other network mining computers 212-218 of the blockchain 221 which also include specialized processors like the specialized processor 211a, according to an embodiment of the invention. The other network mining computers 212-218 similarly contain specialized processors configured to process merchant transactions, according to an embodiment of the invention.

Adding dedicated processors to perform financial/merchant transactions speeds up balancing the collective account ledgers among the mining computers 211-218 in the blockchain network 221, according to an embodiment of the invention. The specialized processors in each of the network mining computers 211-218 reduces the latency in the blockchain network 221, thus, speeding up operation of the entire network, e.g., the wireless network 103 shown in FIG. 1.

Dedicated processors in network mining computers 211-218, such as the dedicated processor 211a, overcome an historic barrier to using blockchain in large-scale commercial settings where thousands of transactions may enter the system every few seconds, each requiring processing and balancing of the collective account ledgers. Conventional processors in a conventional network mining computer in a blockchain network become bogged down when the processors must also process merchant transactions along with all the other transactions required of the processor in a blockchain.

The specialized processors, such as the processor 211a, collectively form a “merchant layer” in the blockchain network 221 and across the entire network, e.g., the wireless network 103 shown in FIG. 1. Depending on the processor speeds of the specialized processors (e.g., the specialized processor 211a) and the level of network traffic, the blockchain network 221 could aim to complete and clear each merchant level transaction in tiny factions of a second per transaction, according to an embodiment of the invention. Using an appropriate array of specialized processors across the merchant layer of the blockchain network 221, the plurality of network mining computers may be configured to process at least 1000 Internet access requests per second, according to an embodiment of the invention.

The specialized processor 211a could potentially comprise any type of dedicated processor. However, given that the blockchain network 221 likely contains a non-trivial number of network mining computers 211-218, e.g., in reality several hundred if not several thousand computers, then the specialized processor 211a should preferably satisfy the characteristics of processing the tasks asked of it within the maximum time allowed for such transactions while also being sufficiently low cost to enable commercial deployment. In other words, simple circuits could be used for the specialized processors 221a, but they would likely not be able to process transactions at required speeds, and supercomputers could be used as the specialized processors 221a, but they would likely not, be commercially feasible. The specialized processor 221a may perform its actions by accessing the portion of memory in its network mining computer that holds the account ledger containing cryptocurrency, e.g., a given user's cryptocurrency, according to an embodiment of the invention. The specialized processor 221a may increment or decrement the account ledger as appropriate for a given transactions, according to an embodiment of the invention.

For example, the specialized processor 211a could comprise any generation of Raspberry Pi devices, according to an embodiment of the invention. Raspberry Pi's comprise a variety of small single-board computers developed by the Raspberry Pi Foundation.

The original Raspberry Pi architecture has found application in a variety of areas, such as, robotics. A typical Raspberry Pi does not include peripheral devices or cases. Many Raspberry Pi boards are approximately credit-card sized and offer a conventional form-factor.

Several generations of Raspberry Pi's have been, released. Most models feature a Broadcom system on a chip (SoC) with an integrated ARM-compatible central processing unit (CPU) and on-chip graphics processing unit (GPU).

Processor speed ranges from 700 MHz to 1.4 GHz for the Pi 3 Model B+; on-board memory ranges from 256 MB to 1 GB RAM. The Raspberry Pi 2B uses a 32-bit 900 MHz quad-core ARM Cortex-A7 processor. The Broadcom BCM2835 SoC used in the first generation Raspberry Pi includes a 700 MHz ARM11 76JZF-S processor, VideoCore IV graphics processing unit (GPU), and RAM. The ARM11 76JZF-S processor is the same CPU used in the original Apple iPhone, although at a higher clock rate, and mated with a faster GPU. The Raspberry Pi 2 V1.1 employs a Broadcom BCM2836 SoC with a 900 MHz 32-bit, quad-core ARM Cortex-A7 processor, with 256 KB shared L2 cache. The Raspberry Pi 2 V1.2 was upgraded to a Broadcom BCM2837 SoC with a 1.2 GHz 64-bit quad-core ARM Cortex-A53 processor, the same SoC which is used on the Raspberry Pi 3, but underclocked (by default) to the same 900 MHz CPU clock speed as the V1.1. The Raspberry Pi 3+ uses a Broadcom BCM2837B0 SoC with a 1.4 GHz 64-bit quad-core ARM Cortex-A53 processor, with 512 KB shared L2 cache.

While operating at 700 MHz by default, the first generation Raspberry Pi provides a real-world performance roughly equivalent to 0.041 GFLOPS. On the CPU level the performance is similar to a 300 MHz Pentium II of 1997-99.

Raspberry Pi 2 V1.1 includes a quad-core Cortex-A7 CPU running at 900 MHz and 1 GB RAM. In parallelized benchmarks, the Raspberry Pi 2 V1.1 could operate up to 14 times faster than a Raspberry Pi 1 Model B+. The Raspberry Pi 3, with a quad-core ARM Cortex-A53 processor, offers roughly ten times the performance of a Raspberry Pi 1.

The Pi Zero can be used as a USB device that is plugged into another computer via its USB port.

Various embodiments of the invention have been described in detail with reference to the accompanying drawings. References made to particular examples and implementations are for illustrative purposes, and are not intended to limit the scope of the invention or the claims.

It should be apparent to those skilled in the art that many more modifications of the wireless network besides those already described are possible without departing from the inventive concepts herein. The inventive subject matter, therefore, is not to be restricted except by the scope of the appended claims. Moreover, in interpreting both the specification and the claims, all terms should be interpreted in the broadest possible manner consistent with the context.

Headings and sub-headings provided herein have been provided as an assistance to the reader and are not meant to limit the scope of the invention disclosed herein. Headings and sub-headings are not intended to be the sole or exclusive location for the discussion of a particular topic.

While specific embodiments of the invention have been illustrated and described, it may be clear that the invention is not limited to these embodiments only. Embodiments of the invention discussed herein may have generally implied, the use of materials from certain named equipment manufacturers; however, the invention may be adapted for use with equipment from other sources and manufacturers. Equipment used in conjunction with the invention may be configured to operate according to conventional protocols (e.g., Wi-Fi) and/or may be configured to operate according, to specialized protocols. Numerous modifications, changes, variations, substitutions, and equivalents may be apparent to ordinary artisans without departing from the spirit and scope of the invention as described in the claims. In general, in the following claims, the terms used should not be construed to limit the invention to the specific embodiments disclosed in the specification, but should be construed to include all systems and methods that operate under the claims set forth hereinbelow. Thus, it is intended that the invention covers the modifications and variations of this invention provided they come within the scope of the appended claims and their equivalents.

It should be noted that while many embodiments of the invention described herein are drawn to a wireless network, various configurations are deemed suitable and may employ various computing devices including servers, interfaces, systems, databases, agents, engines, controllers, or other types of computing devices operating individually or collectively. One should appreciate that any referenced computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed wireless transceiver technology and the blockchain, among other things.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

As used herein, “coupled to” is intended to include both direct coupling (in which two elements that are coupled to each other contact each other) and indirect coupling (in which at least, one additional element is located between the two elements). Therefore, the terms “coupled to” and “coupled with” are used synonymously. The terms “coupled to” and “coupled with” are also used euphemistically to mean “communicatively coupled with” where two or more networked devices can send or receive data over a network.

We claim:

1. A distributed wireless network, comprising:
a plurality of wireless communication units, each communication unit having:
a processor:
a memory having a cryptocurrency bank; and
an adaptive antenna array capable of using a non-line-of-sight propagation channel;
a plurality of wireless base stations, each wireless base station having:
a processor;
an adaptive antenna array capable of using a non-line-of-sight propagation channel, wherein the adaptive antenna array and an adaptive antenna array of, a wireless communication unit of the plurality of wireless communication units form at least one communication link; and
an Internet communication switch;
a blockchain network, comprising a plurality of interlinked network mining computers, each network mining computer having:
an account ledger in a memory having an entry corresponding to the cryptocurrency bank,
wherein the processor in a communication unit of the plurality of communication units sends an Internet access request to a wireless base station of the plurality of wireless base stations via the adaptive antenna array, wherein the processor in the wireless base station of the plurality of wireless base stations sends the Internet access request to the blockchain network wherein each network mining computer receives the Internet access request, decrements the entry corresponding to the cryptocurrency bank, grants Internet access, wherein the blockchain network sends an Internet grant message to the wireless base station of the plurality of wireless base stations, wherein the wireless base station of the plurality of wireless base stations sends the Internet grant message to the communication unit of the plurality of communication units, and wherein the processor in the communication unit of the plurality of communication units decrements the cryptocurrency bank by an amount corresponding to the Internet grant message.

2. The distributed wireless network of claim 1 wherein each network mining, computer of the plurality of network mining computers further comprises:
a processing unit dedicated to computing financial transactions, including the Internet access request,
wherein the plurality of processing units among the plurality of network mining computers forms a merchant layer in the blockchain network.

3. The distributed wireless network of claim 2 wherein the plurality of processing units in the plurality of network mining computers are configured to process at least 1000 Internet access requests per second.

4. The distributed wireless network of claim 3 wherein the plurality of processing units in the plurality of network mining computers have a Raspberry Pi architecture.

5. The distributed wireless network of claim 1 wherein cryptocurrency in the cryptocurrency bank comprises a cryptocurrency asset native to the distributed wireless network.

6. The distributed wireless network of claim 1 wherein the adaptive antenna array of the wireless communication unit of the plurality of wireless communication units and the adaptive antenna array of the wireless base station of the plurality of wireless base stations are configurable for operation in a variety of radio spectrums.

7. The distributed wireless network of claim 6 wherein the wireless communication unit of the plurality of wireless communication units and the adaptive antenna array of the wireless base station operate in an unregulated part of the radio spectrum.

8. The distributed wireless network of claim 6 wherein the adaptive antenna array of the wireless communication unit of the plurality of wireless communication units and the adaptive antenna array of the wireless base station of the plurality of wireless base stations have 105 BPS/Hz spectral efficiency for outdoor wireless in sub-6 GHz bands.

9. The distributed wireless network of claim 6 wherein the adaptive antenna array of the wireless communication unit of the plurality of wireless communication units and the adaptive antenna array of the wireless base station of the plurality of wireless base stations communicate using the 3GPP 5G communication standard.

10. The distributed wireless network of claim 6 wherein the adaptive antenna array of the wireless communication unit of the plurality of wireless communication units and the adaptive antenna array of the wireless base station of the plurality of wireless base stations provide autonomous active self-interference cancellation.

11. The distributed wireless network of claim 6 wherein the adaptive antenna array of the wireless communication unit of the plurality of wireless communication units and the adaptive antenna array of the wireless base station of the plurality of wireless base stations include a beamforming network that performs time-space adaptive processing of each link to optimally equalize a multipath channel to enhance signal to noise ratio, the beamforming network using extreme interference cancellation that inverts a channel from each adaptive antenna in the adaptive antenna array and eliminates interference between the channels from each adaptive antenna in the adaptive antenna array, by directing spatial nulls in the array antenna pattern in the directions of all interfering terminal broadcast radio forming a beam peak in the direction of the desired terminal broadcast radio.

6. The distributed wireless network of claim 6 wherein the adaptive antenna array of the wireless communication unit of the plurality of wireless communication units and the adaptive antenna array of the wireless base station of the plurality of wireless base stations support at least one of fixed, mobile, and IoT services.

13. The distributed wireless network of claim 1 the cryptocurrency bank provides an anti-spam function since Internet access requires decrementing the cryptocurrency in the cryptocurrency bank.

14. The distributed wireless network of claim 1 wherein the processor of the at least one wireless communication unit of the plurality of wireless communication units calculates an inflation rate for the cryptocurrency at one of a fixed or nominal rate.

15. The distributed wireless network of claim 1 wherein the at least one wireless communication unit of the plurality of wireless communication units comprises one of a personal computer, a laptop computer, a desktop computer, a pad computer, and a mobile phone, wherein the adaptive antenna array has been configured as an attachment to the one of personal computer, laptop computer, desktop computer, pad computer, and mobile phone.

16. The distributed wireless network of claim 1 wherein each network mining computer of the plurality of interlinked network mining computers produces a timestamp for each function performed.
